(19) United States
(12) Patent Application Publication
(10) Pub. No.: US 2025/0004282 A1
(43) Pub. Date: Jan. 2, 2025

(54) MOUNTING STRUCTURE FOR TECHNOLOGICAL COMPONENTS ADAPTED TO CANINE EYEWEAR

(71) Applicant: AdMedia - Innovation and Technology, Unipessoal Lda, Funchal (PT)

(72) Inventors: Pedro Miguel Freitas NUNES, Funchal (PT); Joana Isabel Alves Gonçalves, Caniço (PT); André Filipe Mendonça Conde, Funchal (PT)

(21) Appl. No.: 18/758,408

(22) Filed: Jun. 28, 2024

Related U.S. Application Data
(60) Provisional application No. 63/524,142, filed on Jun. 29, 2023.

(51) Int. Cl. G02B 27/01; A01K 15/02; A01K 29/00; H04N 7/18

(52) U.S. Cl. CPC G02B 27/0176; A01K 15/021; A01K 29/005; G02B 2027/0154; H04N 7/183

(57) ABSTRACT

A canine eyewear structure that integrates cutting-edge technologies such as waveguide technology, a 360° camera, GPS, flashlight, and audio system. It is adjustable to different shapes and materials, enabling seamless integration of various components. The structure includes a 360° camera for recording surroundings and two optical modules with waveguide technology that project signals, videos, or images onto the dog's eyes through one or two lenses. It utilizes screws, strong materials, adhesives, adapters, cables, and wireless connectivity for precise and secure placement. Protective plastic structures safeguard electronic components, ensuring longevity and protection against damage. The design considers the anatomical features of dogs for a comfortable and secure fit.

### FIELD OF DISCLOSURE

This disclosure generally relates to “Canine Eyewear” or “Pet Accessories.” Specifically, it pertains to technology-related components and their mounting structures designed for use in eyewear for canines.

### BACKGROUND

The creation of the canine eyewear technological component adaptation structure arose as a result of a growing need to provide a more advanced and interactive experience for dog owners and handlers. As pet lovers and technology enthusiasts, we realized that traditional methods of monitoring and interacting with dogs were limited, for both professional and leisure purposes. Current offerings for head-mounted display devices are limited, particularly in their applicability to animals. While emerging solutions for dogs exist, they are still in their early stages. To address this gap in the market, we have developed the presently disclosed canine eyewear technological component adaptation mounting structure (MSTC). Our innovation is designed to meet the specific needs of working dogs in defense, security, and civil protection sectors, providing advanced features such as a 360° camera and waveguide-equipped optical modules. By enhancing situational awareness and communication capabilities, the present disclosure offers a comprehensive solution to fulfill all the requirements of handlers or trainers. With its versatile applications in various operational environments, our system fills a crucial void in the industry. Furthermore, the fact that this MSTC has the potential to integrate a myriad of different components in any type of canine goggles, makes it very flexible and easy to use with any dog breed, eyewear type and/or brand, and by any person (handler, trainer, pet owner, keeper or others) in a plethora of applications and situations.

Some of the most challenging activities that dogs perform today include search and rescue of stranded or injured humans or animals, and detection of hazardous substances or materials (Jenkins et al., 2018). These activities require dogs to work in situations with often challenging conditions, under the guidance of a human handler who needs to direct them over varying distances and through various visual and auditory obstacles.

Maintaining communication between a handler and his canine partner is essential to the success of a field mission and, for that very reason, several remote signaling systems have been developed over time. Some of them involve the use of visual signals but are only effective when there is a direct line of sight between the handler and the dog. Others involve the use of auditory cues, but their effectiveness can be severely limited by ambient noise. In addition, it is often necessary for handlers to send messages to dogs silently and out of sight. For example, in explosive detection missions in a possible terrorist attack environment or in military missions where, for security reasons, to avoid alerting the enemy to the presence of the team or the dog, it is highly desirable that a handler be able to send silent instructions in real-time to the dog from a safe position (Byrne et al., 2017).

The area of research and development associated with technologies for service dogs has been growing in the last decade, resulting in several published studies with promising results for technological systems and devices intended for these animals. These systems typically involve a receiver worn by the dog and a transmitter by the human, allowing the latter to direct the movements and actions of the former via remotely transmitted acoustic, tactile/haptic or visual commands.

There are several types of one-way communication systems (dog to handler/person, or person to dog) but also others that allow a two-way communication path in both directions; communication that can be by voice and/or sounds using audio components, video transmission through cameras, lasers or other visual systems, and even various types of sensors or GPS trackers for real-time location information.

With the versatility of the device of the present disclosure, it is possible to include all these communication components simultaneously, adapted to glasses to be worn by the dog. And, by enabling this, we are significantly increasing the full capacity and potential of human-dog communication, in a way that would be impossible with individual use of each system. To our knowledge, there are no current solutions that allow for the use of several technological components at the same time, by theoretically any dog.

As previously mentioned, the technological systems and devices for dogs that exist to date, despite being useful and with great potential, have some limitations, including physical and technological limitations, poor resistance and durability, time-consuming and complex training, and limited use due to the wearability of the system not being adaptable or transversal to several types of canine breeds.

The presently disclosed MSTC device is able to respond to these shortcomings. As mentioned above, because there are no problems of physical limitations. It allows for the integration of various technological components into a single structure that serves as an aggregating element. The MSTC is made of a material that presents a perfect balance of strength and durability as well as offering a low weight and compact size. Finally, the presently disclosed device offers ease of adaptation and use by animals as it can be used in any type of glasses that dogs are already familiar with wearing, for example, with appropriate ergonomic characteristics, regardless of the dog's breed or physical characteristics.

A device according to the present disclosure makes it possible to adapt, for example, an augmented reality system for dogs, and a camera with information about the dog in real time, to canine goggles that are already habitually used by working dogs, allowing for the dog to move and act confidently and according to instructions, even without the handler at his side. Ultimately, by providing service dogs with the ability to communicate clearly, we can exponentially increase their capabilities and eventually save more lives.

### SUMMARY

An innovative structure for canine eyewear designed to be adaptable and capable of incorporating various technologies. This structure is prepared to incorporate cutting-edge components such as waveguide technology, a 360° camera, GPS, flashlight, audio system, among others, while also being adjustable to different shapes and materials. The versatility of the structure allows for seamless integration of these technologies, providing a customizable and advanced solution for all users. With its flexible design, secure mounting mechanism, customized fit for dogs, and potential future application for other types of animals, this mounting structure ensures comfort, reliability, and usability. It includes a 360° camera that records the dog's surroundings, and two optical modules with waveguide technology that can transmit signals, videos, or project images onto the dogs' eyes through one or two lenses. The structure's adjustable mounting mechanism ensures secure and precise placement, utilizing screws, strong materials, adhesives, adapters, cables, and wireless connectivity for seamless integration. Protective plastic structures are integrated to safeguard the electronic components, ensuring their longevity and protecting them from potential damage. The design also takes into account the specific anatomical features of dogs, ensuring a comfortable and secure fit. With a wide range of integrated advanced components, a secure mounting mechanism, customized and adjustable design, user-friendly controls, and unparalleled performance, this structure is expected to set new industry standards.

### DETAILED DESCRIPTION OF THE FIGURES

FIG. 1. Exploded view of the goggle mount and connection of the various components.

FIG. 2. Exploded view of the visual module and visual module housing.

FIG. 3. Exploded view of the camera module and camera module housing.

FIG. 4. Front-Side-Exploded view of the MSTC.

FIG. 5. Front view of the MSTC.

FIG. 6. Rear-Side-Exploded view of the MSTC.

FIG. 7. Side-view of the MSTC.

FIG. 8. Side-view of the MSTC as worn by a canine.

FIG. 9. An illustration of a web application associated with the MSTC used to control and monitor the canine eyewear through an online interface.

FIG. 10. A diagram illustrating connection of the components of the system.

FIG. 11. A representation of waveguide technology, illustrating transmission of visual or data information to the user.

### DETAILED SUMMARY

The present invention discloses a novel mounting structure specifically designed to accommodate technological components in canine eyewear. The MSTC comprises a lightweight frame that securely attaches to the canine eyewear, providing a stable and comfortable platform for integrating various technological devices. This structure is specifically intended for mammals, with a particular focus on canines, specifically designed for the unique shape of a dog's head. However, it is not limited to a specific breed or species, and it should be noted that the concepts and principles introduced here can also be extended and customized for application with other species, such as cats and horses. The adaptability of the MSTC allows for its potential utilization across a range of animal types, providing flexibility and broader applicability in various animal-related contexts. Furthermore, it can be applied to working dogs such as police and military, or search and rescue, to service and medical, to competition and hunting, or even to non-professional dogs, just for training, tracking, or entertainment purposes. In fact, this structure can be very useful in the field of canine training as it facilitates remote training, which can be done at any time, even with adverse weather conditions. This also lowers the cost of training time.

The MSTC includes at least two screws that securely fasten the frame to the canine eyewear, ensuring a snug fit without causing discomfort to the dog. The frame is ergonomically designed to distribute the weight of the technological components evenly, minimizing any potential strain on the canine's head or neck.

The featured attachment mechanism enables easy installation and removal of the technological components. This allows handlers or pet owners to swiftly attach or detach devices as needed, ensuring flexibility and adaptability in various operational scenarios.

Overall, the disclosed versatile mounting structure adapted to canine eyewear provides a reliable, comfortable, and versatile solution for integrating various technological components, such as a controller with computing power, an augmented reality (AR) optical module equipped with lenses, a 360° camera, bidirectional audio controls for communication, a light source, and a tracking system. The technological components encompass optics equipment, including one or more lenses with waveguide technology that can function as an AR device, displaying visual content to the animal. An outward-facing camera captures the animal's line of sight, while a speaker and microphone facilitate audible commands to be transmitted to the dog and allow for receiving audio data from the dog. Additionally, the MSTC can accommodate other features such as various types of light sources (e.g., flashlight, laser) and a tracking system, such as GPS, to provide precise information about the canine's location.

By connecting different devices to any canine goggles, the mounting structure enables humans to view the animal's direct line of sight and transmit visual images back into the animal's field of vision, facilitating clear and unambiguous communication of signals, directions, targets, and visual references. This makes the MSTC innovative in terms of design and the possibility of adding functionalities to so-called common canine goggles enhances the operational capabilities of working canines by facilitating effective communication, visual augmentation, and situational awareness and benefiting both handlers and the overall mission success.

Overall, the main advantages and benefits of the presented structure lie in its ability to enhance functionality, communication, visual capabilities, comfort, adaptability, safety, and reliability, ultimately improving the overall performance, effectiveness, and survivability of working canines and their handlers. More specifically:
1. Enhanced Functionality: The MSTC allows for the integration of various technological components, such as cameras, communication modules, and illumination systems, into canine eyewear. This enhances the functionality and capabilities of working canines, enabling them to perform tasks with increased efficiency and effectiveness.
2. Improved Communication: By incorporating optical and audio modules and bidirectional communication capabilities, the structure facilitates clear visual and audible communication between handlers and canines. This enables precise instructions, commands, and feedback, enhancing teamwork and coordination in various working scenarios.
3. Visual Augmentation: With optics equipment, including lenses with waveguide technology for augmented reality (AR) display, the MSTC can provide visual content to the animal. This visual augmentation can assist canines in navigating complex environments, identifying targets, or providing real-time situational information, enhancing their performance and decision-making abilities.
4. Unambiguous Signals: The structure allows for direct viewing of the animal's line of sight and transmitting visual images back to the animal. This ensures unambiguous signals and visual references, reducing ambiguity in directions, targets, or visual cues. It promotes precise communication and aids canines in understanding and responding accurately to visual cues.
5. Comfort and Adaptability: The MSTC is designed to accommodate the distinct form factor of an animal's head, providing a comfortable fit without compromising their movement or well-being. The adjustability and customization options ensure compatibility with different breeds and sizes of canines, allowing for a secure and personalized fit.
6. Versatility and Expandability: The structure permits the adaptation of different technological components, enabling customization based on specific operational requirements. It offers the flexibility to add or remove devices, supporting future advancements and upgrades in technology without the need for significant modifications.
7. Increased Safety and Survival: By incorporating a tracking system, such as GPS, the MSTC enhances the safety and survivability of canines in various situations. It provides valuable information about the canine's location, aiding in search and rescue missions, maintaining situational awareness, and minimizing the risk of loss or harm to the animal.
8. Sustainability and Eco-friendliness: The material of MSTC, PLA, is biodegradable and derived from renewable resources, promoting a more sustainable and circular economy and reducing the impact on the environment. It also has a low carbon footprint and lower toxicity compared to some other plastics, such as ABS. This can be advantageous during manufacturing, usage, and disposal stages, as it reduces potential harmful effects on animal health and the environment.

### DESCRIPTION OF THE DRAWINGS

The illustrations of the present disclosure constitute examples, and do not limit the embodiments that could come up from this patent, with similar elements as the ones represented in the drawings.

FIG. 1 illustrates an overview of the mounting structure, including the part that connects to canine goggles (1a), the part that accommodates a light-engine and a lens (1b) and the part that encloses the power supply and attaches a camera and an audio system (speaker and microphone) (1c). Both drawings show the MSTC, revealing its internal features, such as attachment mechanisms, and other elements including a laser (a) and two flashlights with sensors (b). The structure of the invention is designed for secure attachment to dog glasses using screws (c), ensuring stability during use. The use of screws to secure the structure onto the dog goggles provides a sturdy and reliable attachment. This ensures that the structure remains firmly in place during use, even during active movements or outdoor activities, maintaining stability and preventing unintended displacement. The MSTC can incorporate customizable attachment points, such as the ones depicted by a) and b) that allow for the seamless integration of a variety of technological components. These attachment points could be designed to accommodate different sizes and types of devices, enabling canines to utilize a wide range of tools, such as cameras, sensors, communication modules, or illumination systems, based on specific mission requirements. The components of the invention play crucial roles in ensuring the overall functionality and stability of the structure.

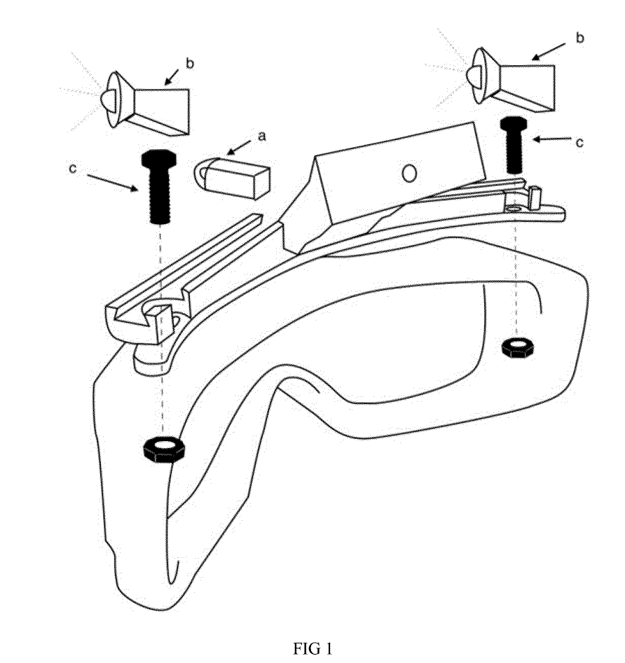

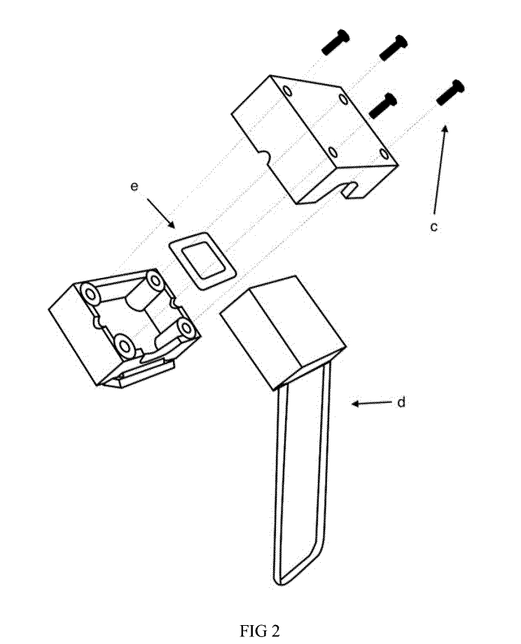

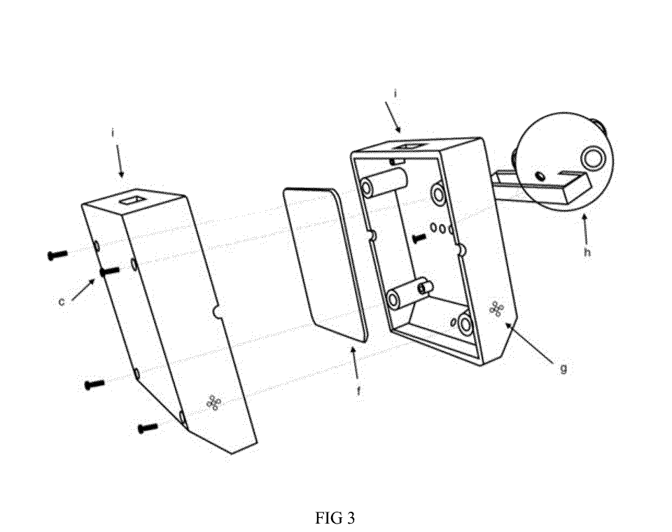

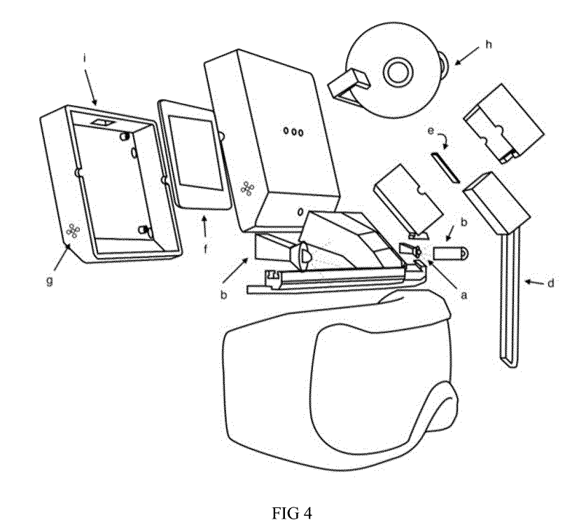

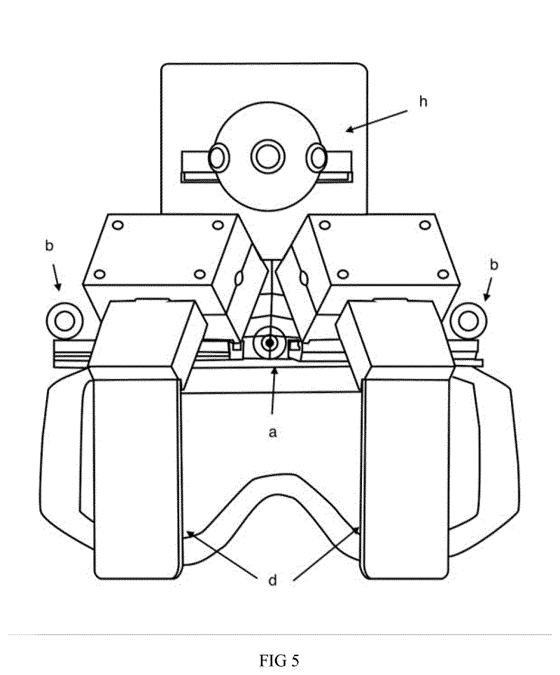

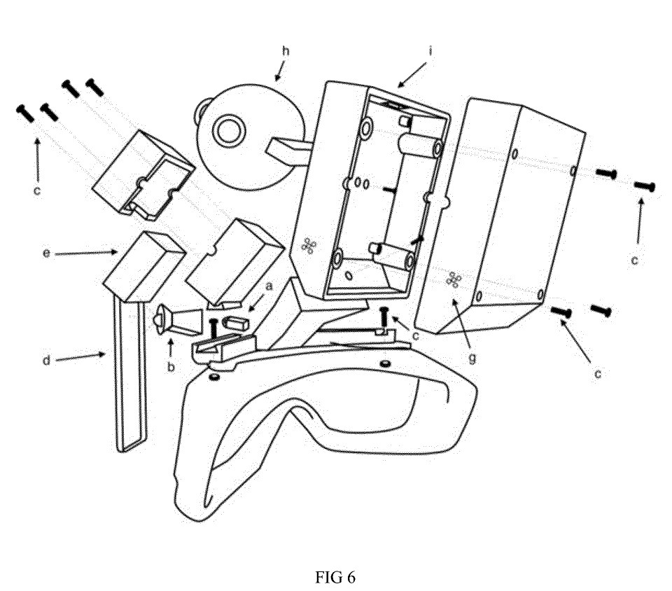

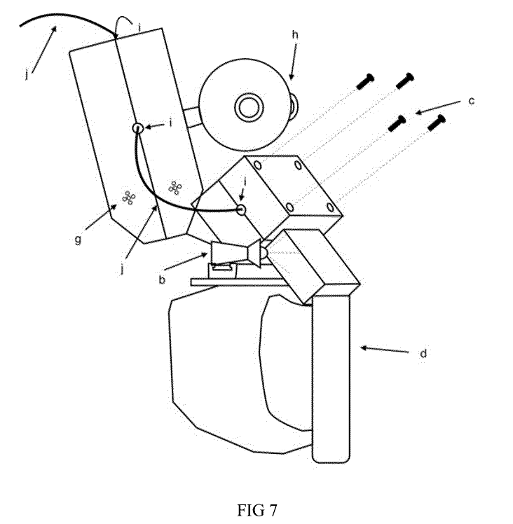

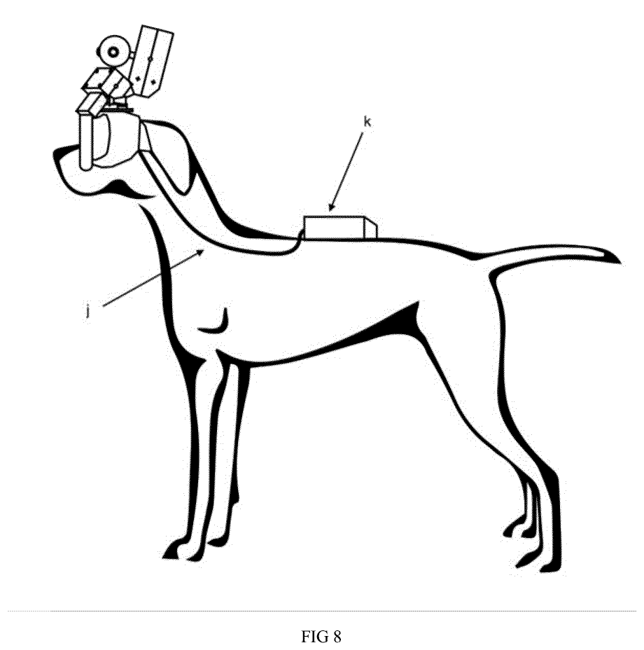

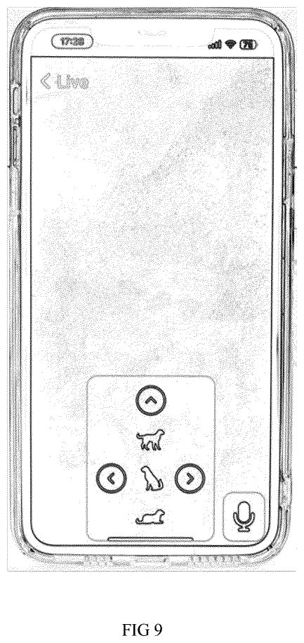

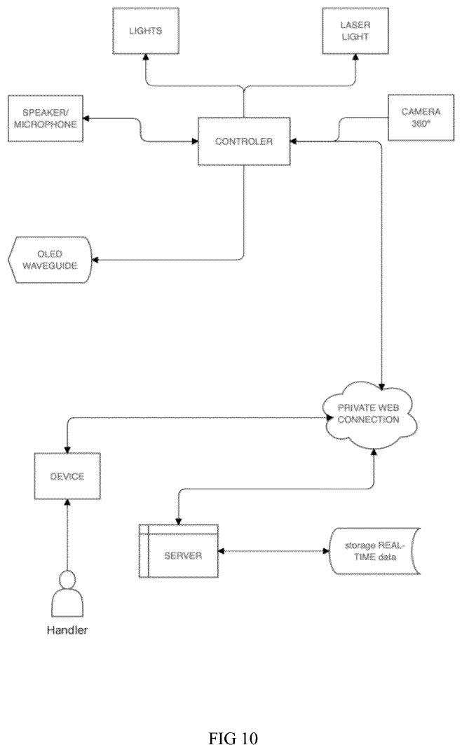

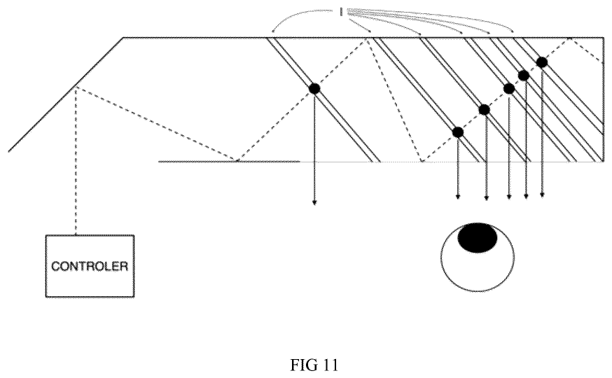

The lenses are key components that receive and display images (d). They are connected to the light-engine board (e), which acts as the source of image transmission. This integration allows for seamless communication between the lenses and the image source, ensuring that the desired visual information is accurately conveyed to the user. The light-engine board is further linked to the power-supply and image transmission component of the controller (f), enabling seamless communication and functionality. In addition to the lens connection, the controller is interconnected with the audio system (speaker and microphone) (g), camera (h), flashlights (b), and laser (a) components, enabling comprehensive control and operation. This integration allows for precise management and adjustment of the audio, light, and laser functionalities to suit specific requirements. By utilizing a robust mounting structure and establishing efficient connections between the lenses, light-engine board, power-supply, and other components, the invention ensures a reliable and seamless operation. The interconnected controller (that will be described below) offers enhanced control over the features, enabling precise and tailored usage.

The MSTC is made of PLA. This material provides a reliable foundation for integrating technological components and aligns with environmentally conscious practices. PLA is derived from renewable resources such as cornstarch or sugarcane, making it a more environmentally friendly option compared to traditional plastics. It is biodegradable under the right conditions, allowing for reduced environmental impact and promoting sustainability. Furthermore, PLA has good stiffness and rigidity, which provides structural integrity to the MSTC. It can maintain its shape and withstand moderate loads, ensuring stability and support for the attached technological components. By utilizing PLA, we not only consider the environmental advantages but also prioritize the well-being and functionality of the canine user. The lightweight and compact nature of the PLA-based structure helps maximize the dog's comfort, reduce physical strain, and allow for improved maneuverability in various operational scenarios.

Other materials may also be used to build the mounting structure, according to the specific usage requirements, such as wood, carbon, metal, nylon, resin or other types of plastic (ABS, PETG, etc.).

The MSTC may incorporate vibration-dampening mechanisms, like rubber, springs or dampers to minimize any vibrations or impacts that can affect the stability and functionality of the technological components. This feature is particularly beneficial in high-intensity situations, providing reliable performance and preventing damage to the devices.

Some components of the structure could be constructed using innovative shock-absorbing materials, such as silicone or TPU. These materials help minimize vibrations and impacts, thereby protecting the technological components from damage and ensuring their reliable performance even in high-intensity situations. The inclusion of such materials enhances the overall durability and longevity of the MSTC.

It is also possible to improve the water resistance of the MSTC by applying post-processing sealants, such as epoxy resin or varnish, or by treating the surface with waterproofing coatings or hydrophobic sprays. This is important to protect the technological components in order to withstand adverse weather conditions, environments with water and/or humidity and the dog's saliva.

FIGS. 4 and 6 depict how the different technological devices are attached, positioned, and interconnected within the structure, from a lateral (4) and front view (6). The MSTC is designed in a manner that allows for the adaptation of the following components.
Laser (a): The incorporation of a laser module within the structure enables precise object indication and instruction for dogs. By emitting a focused laser beam, users can direct the dog's attention to specific objects or targets, facilitating training, obedience commands, or assistance tasks. The adjustable settings of the laser module allow for customization based on different scenarios, enhancing training efficiency and improving communication between humans and dogs.
Flashlight with Light Sensor (b): The automatic activation of the flashlight through a light sensor provides added convenience and functionality within the MSTC. By adapting to different lighting conditions, the flashlight ensures that the dog's environment remains well-illuminated, enhancing visibility and safety during various activities or in low-light environments.
Lenses (d) and light engine (e): The integration of advanced lens technology, such as waveguide technology, within the structure serves the purpose of providing immersive visual experiences for dogs. These lenses enable the transmission of signals, videos, and images directly to the dog's eyes, enhancing their perception of the surrounding environment. By offering customizable options like 2D or 3D imagery, adjustable lighting, and contrast settings, the lenses ensure that the visual information presented to the dog is tailored to their specific needs and preferences. The transparent nature of the lenses also guarantees that the dog maintains its natural vision, avoiding any potential loss of sight or disorientation.
Power-Supply and Image Transmission Component (f): The power-supply is responsible for providing the necessary electrical power to the components of the structure, ensuring their proper functioning. This image transmission component, connected to the light-engine board, facilitates the efficient transmission of images to the lenses. Together, these components ensure a reliable and continuous supply of power and smooth transmission of images, contributing to the overall functionality of the structure.
Audio System (g): The inclusion of a micro speaker and microphone within the MSTC aims to facilitate effective communication between humans and dogs. The micro speaker emits low-frequency signals specifically designed to be audible to canines, ensuring clear and intelligible communication. The microphone captures the dog's responses, vocalizations, or any relevant auditory feedback, allowing for seamless two-way communication. By integrating these components, the structure enhances human-canine interactions, supports training techniques, and strengthens the bond between humans and dogs.
360° Camera (h): The integration of a 360° camera within the MSTC significantly enhances the monitoring capabilities for dogs. This camera provides a comprehensive view of the dog's surroundings, leading to improved situational awareness and enabling effective surveillance. Equipped with high-resolution imaging capabilities, the camera captures detailed visuals, facilitating clear monitoring and analysis of the environment. Its instant recording feature allows for quick and seamless capturing of important events or observations. Additionally, the camera incorporates image stabilization technology to minimize vibrations and motion blur, ensuring stable and high-quality footage. The camera's night vision technology enables clear visibility in low-light conditions, ensuring continuous monitoring even in challenging lighting situations. This feature proves particularly valuable for search and rescue missions, training sessions, and assessing the dog's well-being in various environments. Positioned at the top of the structure, the camera benefits from an elevated perspective, enhancing its surveillance capabilities. It offers a wide field of view, capturing a broad range of angles and details. This extensive coverage ensures that no critical information or potential threats go unnoticed, providing a comprehensive view of the dog's surroundings. Moreover, the placement of the camera at the top emphasizes its significance within the MSTC. Serving as a central component, it plays a crucial role in monitoring the dog's environment and ensuring its safety and well-being.
GPS: The integration of a GPS system within the structure automates and streamlines the navigation of dogs without relying on human intervention. By leveraging satellite-based positioning technology, the GPS system enables precise tracking of the dog's location in real-time. This feature allows for autonomous navigation along pre-programmed routes, promoting independence and increasing efficiency, particularly in scenarios such as search and rescue operations or guided assistance tasks.

FIGS. 6 and 7 illustrate the adjustable mounting structure that will connect the electronic components to the canine eyewear, including all the mounting parts, when opened (6) and closed (7).

The MSTC is designed with a secure mounting mechanism, utilizing screws (c), strong materials, cables (j) and cable entries (i), and wireless connectivity for seamless integration. Protective plastic structures are also integrated to safeguard the electronic components, ensuring their longevity and protection. The design takes into account the specific anatomical features of dogs, providing a comfortable and secure fit.

Goggles designed for dogs are crucial in providing eye protection and comfort, safeguarding their eyes during outdoor adventures. The MSTC incorporates a set of mandatory characteristics that enhance the performance and usability of these goggles: lightweight construction, minimizing any potential discomfort for dogs and ensuring ease of movement during activities; secure and proper fit; comfort and breathability, allowing use for extended periods and preventing excessive heat build-up by promoting airflow around the eyes. The structure is adaptable to theoretically any type of off-the-shelf canine eyewear. The presently disclosed MSTC can adapt to a variety of styles and sizes to cater to different dog breeds and individual preference and are recognized for their commitment to quality, comfort, and durability.

The MSTC may incorporate innovative adjustable straps, such as sliding elements, that offer a secure and comfortable fit for canines of different sizes and breeds. These straps can feature a specialized mechanism or design that allows for quick and easy adjustment, ensuring a snug fit without causing discomfort or hindering the canine's movement. Moreover, the structure may include a unique quick-release attachment mechanism or a snap-on system that allows for easy installation and removal of the technological components. This feature would enable handlers to swiftly attach or detach devices as needed, providing flexibility and adaptability in various operational scenarios. Additionally, the MSTC may include strategically positioned cable management channels or clips, ensuring neat and organized routing of cables connecting the technological components. This eliminates cable entanglement, reduces the risk of accidental disconnections, and maintains a streamlined and professional appearance.

FIG. 8 is representative of the entire system (MSTC, technological components and eyewear) when used by a dog, from a lateral point of view. The drawing demonstrates the profile of the mounting structure when attached to canine eyewear, showcasing its shape, size, and positioning on the canine's head and back, where the controller will be in a vest or similar (k).

The incorporation of a microcontroller with computing power within the MSTC serves as the central processing unit responsible for managing various functions and interactions. With its robust configuration and wireless connectivity capabilities, the controller enables seamless communication and data transfer between the lenses and external devices. It ensures efficient data storage and retrieval, handles complex computations and tasks, and offers compatibility with different peripherals. By integrating a powerful microcontroller, the structure empowers users to take full advantage of the advanced capabilities and functionalities of the canine eyewear. It is connected to all the different components (speaker, flashlights, laser, camera, light engine and lenses), allowing for precise control and adjustment. This interconnected system enables the user to effectively control and utilize all the desired functionalities, enhancing the overall usability and adaptability of the invention.

The components within the MSTC feature an ergonomic design that takes into consideration the unique anatomical characteristics of canines, including different breeds and sizes. This design ensures a proper and secure fit, distributing the weight of the technological components evenly across the canine's head and minimizing any strain or discomfort that could hinder their performance. The design also offers adjustability and customization options to accommodate variations in head shape and size, ensuring a proper and secure fit for different canines. The use of PLA in the disclosed structure aligns with the environmental advantages it offers while addressing the specific needs of our canine users. One of the key benefits is its lightness and compactness, which are crucial for the comfort and agility of the dog wearing the mounting structure. This lightness is essential for preventing fatigue and maintaining the canine's natural movement and endurance during tasks or missions. Additionally, PLA's compactness allows for a streamlined and efficient design. The structure can be optimized to have a minimal footprint, ensuring that it doesn't impede the dog's movement in tight spaces or obstruct its ability to navigate through challenging environments. The compactness of the PLA structure contributes to the canine's mobility and maneuverability, enhancing its overall performance and effectiveness.

FIG. 9 depicts a screenshot of the user-friendly and intuitive app interface designed to control the various technological components integrated into the structure. The image showcases a mobile device screen displaying the app's main dashboard.

The app interface features a range of control options organized in a user-friendly layout. The control panel on the left-hand side of the screen allows the user to access different functions and settings. It includes buttons and sliders for adjusting the brightness of the light source, activating the augmented reality (AR) mode, initiating bidirectional audio communication, and toggling the tracking system. The design of the app interface emphasizes simplicity and user-friendliness, ensuring that handlers can easily navigate through the different controls and access the desired functionalities without distractions or complications. Users have the ability to control the information transmitted to the technological components, including videos, signals, or images, through the application. They can conveniently manage and customize the content that is displayed, ensuring effective communication and interaction with the lenses.

Furthermore, the app interface can also incorporate an intuitive gesture-based control system, enabling the user to perform specific actions by swiping or tapping on the screen. For example, a swipe in a particular direction may trigger the dog to change its direction, or a tap on an icon may activate a predefined command or task.

The application, developed for controlling the information transmitted to the lenses, offers users the ability to access and manage the application through a range of devices. The invention ensures flexibility and convenience by allowing access and control through devices such as smartphones, computers, smartwatches, and more. For example, users can access and control the application through their smartphones by installing the dedicated mobile application or accessing the web-based version through a compatible web browser. The application can also be accessed and controlled through computers, including desktops and laptops, providing a larger screen and enhanced functionality for managing the received and transmitted information. Finally, for added convenience, the application can be accessed and controlled through compatible smartwatches, a compact and wearable option. These mentioned devices are examples of the wide range of devices that can be used to access and control the application. Other compatible devices may include tablets, wearable devices, gaming consoles, and more, depending on the supported platforms and interfaces.

FIG. 10 illustrates a comprehensive visual representation of the operational scheme of the mounting structure and its integrated technological components. The image showcases the seamless interaction between the various elements involved in the system's functionality and the efficient flow of information and communication between the handler and the dog, empowering them to effectively collaborate, navigate, and accomplish tasks with enhanced situational awareness and control.

The main components depicted in the image include the mounting structure securely fastened to the canine goggles with the embedded technological features, and the handheld device used by the handler to monitor and control the system. The image illustrates the bidirectional communication between the handler and the dog through the audio and visual controls. The handler can transmit audible and visible commands to the dog via the built-in speaker and optical module, while also receiving audio and visual data captured by the dog through the integrated microphone and camera, respectively. This communication capability ensures clear and efficient coordination between the two parties.

FIG. 11 is a diagram representative of the optical model used: a waveguide technology. There are several types of optical combiners available, but to date, only waveguides can guarantee the desired visual quality for a compact system. As the name implies, a waveguide is a physical structure that conducts/guides light waves to the user's eye. When applied to eyeglasses, waveguides help manipulate light by bending and combining it, directing it towards the eye and creating virtual images that are superimposed on the user's environment. These waveguides use total internal reflection (TIR) to propagate a light field. In a TIR system, light is reflected between the inner and outer edges of the waveguide layer, with several transflective mirrors (I), resulting in minimal light loss. So, in AR glasses, for example, waveguide technology is used to project images onto a small peripheral area of the viewfinder lens using an image projector that is hidden from the wearer's direct line of sight. The waveguide then propagates the image along the lens to an extraction point in front of the eye. Essentially, the waveguide acts like a transparent periscope with one entrance pupil and usually several exit pupils. Through a combination of waveguides with glass substrates with a high refractive index, it is also possible to increase the TIR angle, which results in a larger field of view.

The optical model developed for image display addresses the challenges associated with varying light conditions and reflections, ensuring an optimal viewing experience. The invention incorporates innovative techniques to manage light transmission, minimize reflection, and enhance image clarity. More specifically, the optical model takes into consideration different light conditions, such as bright sunlight, indoor lighting, and low-light environments, optimizes light transmission and adjusts image display parameters to provide clear visibility under various lighting conditions; utilizes anti-reflective coatings, polarizers, or other appropriate techniques to minimize unwanted reflections and improve image contrast, ensuring a more immersive viewing experience; ensures accurate and high-quality image reproduction with sharp and vibrant content by employing advanced optical components, such as lenses, prisms, or waveguides, the model optimizes image formation and minimizes aberrations.

### CONCLUSION

The MSTC introduces a structure for canine eyewear that represents a significant improvement over existing solutions in the market. Our innovative structure builds upon these foundations and introduces new elements and capabilities that set it apart. By combining versatility, advanced components, and a secure mounting mechanism, the MSTC provides a comprehensive solution for enhancing the dog's visual experiences, communication, monitoring capabilities, and navigation.

In comparison to existing patents, the presented structure has the ability to incorporate cutting-edge technologies that were not previously integrated into canine eyewear. The seamless integration of these technologies enables a new level of functionality and performance.

Furthermore, the MSTC allows for customization and adaptability, accommodating different shapes and materials, ensuring a comfortable fit for dogs of various sizes and breeds. Our design takes a leap forward by offering the possibility of introducing components such as waveguide technology, a 360° camera, GPS, flashlight, audio system, and more, and all simultaneously. These additions greatly enhance the capabilities of the canine eyewear, providing a comprehensive and advanced solution for the dog's well-being and interaction with its environment. The accompanying figures depict key aspects of the disclosed structure and its operation, showcasing its potential to revolutionize the field of canine eyewear. By improving upon existing patents and introducing new elements, the MSTC sets new industry standards and opens up exciting possibilities for canine eyewear technology.

In conclusion, the present disclosure improves upon existing technology by introducing new elements and capabilities that differentiate it from the current market offerings. With its advanced features, customization options, and seamless integration of cutting-edge technologies, the MSTC represents a significant advancement in the field of canine eyewear.

### Examples of Certain Embodiments

These embodiments represent a few examples of the variations and features that can be incorporated into the mounting structure for technological components adapted to canine eyewear. The specific configuration and combination of components can be customized based on the intended application, operational requirements, and the needs of the canine users.

### 1: Basic Mounting Structure

According to certain embodiments, a lightweight and adjustable head fitting structure is designed to accommodate the distinct form factor of an animal's head. It can feature secure straps and buckles to ensure a snug and comfortable fit. The mounting structure can include attachment points for integrating various technological components such as a controller, an AR optical module, a camera, and audio controls.

### 2: Modular Mounting Structure

According to certain embodiments, a modular design allows for easy customization and adaptability to different mission requirements. The mounting structure can include interchangeable modules, each designed to accommodate specific technological components. For example, one module can be dedicated to the attachment of a 360° camera, while another module can be designed to integrate an additional lighting source. This modular approach enables versatility and flexibility in configuring the system based on specific needs.

### 3: Advanced Sensor Integration

According to certain embodiments, the mounting structure can incorporate advanced sensor integration for enhanced functionality. It can include additional sensors such as thermal imaging sensors or gas detectors to provide the canine with the ability to detect and respond to specific environmental cues. The sensors can be seamlessly integrated into the structure, ensuring optimal positioning and minimal interference with the dog's natural movement.

### 4: Ergonomic Design for Canine Comfort

According to certain embodiments, comfort and ergonomic fit of the mounting structure can be optimized. These embodiments can utilize soft and breathable materials for the parts that come into direct contact with the dog's head, minimizing discomfort and potential skin irritation. The design also takes into account the natural anatomical features of canines, allowing for freedom of movement and reducing any hindrance or restriction during operations.

### 5: Enhanced Durability and Impact Resistance

According to certain embodiments, the ruggedness and durability of the mounting structure to withstand challenging operational conditions are optimized. Certain embodiments can incorporate reinforced materials or protective layers to enhance impact resistance, ensuring the structure can withstand accidental impacts or rough handling. This robust design can allow the system to reliably perform in demanding environments and increase the overall lifespan of the structure.

### 6: Wireless Connectivity and Data Transmission

According to certain embodiments, wireless connectivity capabilities are incorporated into the mounting structure. It can include built-in Bluetooth or Wi-Fi modules, enabling seamless communication between the canine's eyewear and external devices such as the handler's smartphone or a central command center. This wireless connectivity allows for real-time data transmission, remote monitoring, and control of the canine's eyewear system.

### 7: Power Management and Energy Efficiency

According to certain embodiments, the mounting structure can integrate a power management system to optimize energy usage and ensure extended operation. It can include rechargeable batteries or energy harvesting mechanisms such as solar panels or kinetic energy converters. The power management system regulates power distribution to different components, prioritizing energy efficiency and maximizing the overall runtime of the system.

### 8: Ergonomic Camera Mounting

According to certain embodiments, an ergonomic camera mounting design is incorporated and can ensure stability and precise alignment of the camera module. It can include adjustable camera mounts that allow for fine-tuning the camera position and angle, ensuring optimal field of view and minimizing image distortion or misalignment during movement. This design feature enhances the accuracy and reliability of the visual feedback provided by the canine's eyewear system.

### 9: Multiple Canine Compatibility

According to certain embodiments, the compatibility of the mounting structure with different canine sizes and breeds is optimized. It can incorporate adjustable components such as straps, buckles, and size adjustment mechanisms to accommodate a wide range of canine head sizes. This flexibility allows the system to be utilized by various canines, promoting versatility and usability across different working dog units or organizations.

### 10: Biometric Monitoring and Health Sensors

According to certain embodiments, biometric monitoring devices and health sensors can be integrated with the mounting structure. It can incorporate sensors to monitor vital signs such as heart rate, temperature, or stress levels of the canine wearer. This data can be transmitted to the handler or a monitoring system, enabling real-time health monitoring and facilitating early detection of any potential health issues or signs of fatigue.

What is claimed is:

1. A structure for canine eyewear comprising:
a versatile design capable of accommodating various technologies and components;
a secure mounting mechanism for precise placement and integration of said technologies and components;
integration of advanced components including but not limited to optical and audio modules, cameras, tracking systems, illumination systems, and more;
adjustable features to accommodate different shapes and materials for a comfortable and secure fit for any dog breed and size; and
protection for electronic components through the integration of protective plastic structures, ensuring longevity and safeguarding against potential damage.

2. The structure of claim 1, further comprising:
an optical module with waveguide technology for transmitting signals, videos, or projecting images onto the dogs' eyes through one or two lenses; and
an adjustable mounting mechanism utilizing screws, strong material, adapters, cables, and wireless connectivity for seamless integration and secure placement.

3. The structure of claim 1, wherein said structure is embedded within canine eyewear and further comprises a controller for easy control and operation.

4. The structure of claim 2, wherein said structure is embedded within canine eyewear and further comprises a controller for easy control and operation.

5. The structure of 1, wherein said structure is adaptable for use with other types of animals, expanding its potential applications beyond canines.

6. The structure of 2, wherein said structure is adaptable for use with other types of animals, expanding its potential applications beyond canines.

7. The structure of 3, wherein said structure is adaptable for use with other types of animals, expanding its potential applications beyond canines.

8. A method for enhancing canine visual experiences, communication, monitoring capabilities, and navigation, comprising the steps of:
providing a structure for canine eyewear as claimed in claim 1;
integrating advanced components and technologies into said structure;
adjusting the structure for a customized and comfortable fit on dogs; and
activating and utilizing the integrated components to enhance visual experiences, facilitate communication, enable effective monitoring, and provide navigation capabilities for dogs.

9. The method of claim 8, wherein the structure further comprises:
an optical module with waveguide technology for transmitting signals, videos, or projecting images onto the dogs' eyes through one or two lenses; and
an adjustable mounting mechanism utilizing screws, strong material, adapters, cables, and wireless connectivity for seamless integration and secure placement.

10. The method of claim 8, wherein said structure is embedded within canine eyewear and further comprises a controller for easy control and operation.

11. The method of claim 9, wherein said structure is embedded within canine eyewear and further comprises a controller for easy control and operation.

12. The method of claim 10, wherein said structure is adaptable for use with other types of animals, expanding its potential applications beyond canines.

13. The method of claim 11, wherein the integrated components and technologies include waveguide technology, a 360° camera, GPS, flashlight, audio system, and more.

14. A system for canine eyewear comprising the structure of claim 1, and further comprising:
a web application for remote control and monitoring of the canine eyewear through an online interface; and
waveguide technology for transmitting visual or data information to the user.

15. The system of claim 14, wherein the structure further comprises:
an optical module with waveguide technology for transmitting signals, videos, or projecting images onto the dogs' eyes through one or two lenses; and
an adjustable mounting mechanism utilizing screws, strong material, adapters, cables, and wireless connectivity for seamless integration and secure placement.

16. The system of claim 14, wherein said structure is embedded within canine eyewear and further comprises a controller for easy control and operation.

17. The system of claim 15, wherein said structure is embedded within canine eyewear and further comprises a controller for easy control and operation.

18. The system of claim 14, wherein said structure is adaptable for use with other types of animals, expanding its potential applications beyond canines.

19. The system of claim 15, wherein said structure is adaptable for use with other types of animals, expanding its potential applications beyond canines

20. The system of claim 15, wherein said system operates based on the integration and interaction of the components and technologies within the structure, providing enhanced visual experiences, communication, monitoring capabilities, and navigation for dogs.
